(19) United States
(12) Patent Application Publication
(10) Pub. No.: US 2018/0157656 A1
(43) Pub. Date: Jun. 7, 2018

(54) Method and System to Construct a Content-Discovery Network

(71) Applicant: Donald S Eaves, Mountain View, CA (US)

(72) Inventor: Donald S Eaves, Mountain View, CA (US)

(21) Appl. No.: 15/428,153

(22) Filed: Feb. 9, 2017

Related U.S. Application Data
(60) Provisional application No. 62/292,869, filed on Feb. 9, 2016.

(51) Int. Cl. G06F 17/30; G06F 17/15; G06Q 50/00

(52) U.S. Cl. CPC G06F 17/30014; G06F 17/30893; G06Q 50/01; G06F 17/30268; G06F 17/15

(57) ABSTRACT

A computer method that networks people around the content that they jointly value by leveraging pre-existing curated collections of links to documents, such favorited photos of individuals on DeviantArt or the citations within a medical journal article. Because the method depends only on collections of curated links to seed it's content-centric networking paradigm, it averts the sparsity problem in initiating such a network, since it provides great value to even the first user, and provides exponentially increasing value as the population of networked users increases.

This method allows its networked users to “like” or “dislike” documents within its database of leveraged documents into one or more personal curations. Individuals are then network with one another by correlating pairs of personal curations, wherein a stronger correlation between likes results in a stronger relationship between the curations and stronger correlations between dislikes and likes weakens the relationships.

### CROSS-REFERENCES TO RELATED APPLICATIONS

This application claims priority from U.S. provisional patent Application No. 62/292,869 Filed Feb. 9, 2016

### FIELD OF THE INVENTION

This invention relates generally to techniques to network people around the content that they jointly value by first analyzing and leveraging pre-existing curated collections of links to documents, such as the favorite photos of individuals on photo sights, the citations within documents within medical journal sites or any other hypermedia database.

### GLOSSARY OF TERMS

Document: is used in the general sense and may refer to any sort of information content including a photo, video, text or person identity.

Like: is used in the general sense and refers to a positive assessment

Dislike: is used in the general sense and refers to a negative assessment

Curation: refers to a collection of links to documents. For example, favorite photos, favorite photo within a particular category, citations within documents as these represent as these represent a set of curated documents centered around the subject matter of the document containing the citations.

### BACKGROUND OF INVENTION

What enables Google's PageRank to rank documents by relevance is the fact that documents are networked by hyperlinks that signal relevance and trust. However, there are two limitations to Google's Page Rank that relate to this invention. First, most new content does not contain hyperlinks (e.g., images, music and video), so there is no hyperlink-based network to leverage. Second, PageRank is most effective at producing a global rank vector, that is generally independent of any individuals personal tastes. While PageRank is very effective for globally accepted objective information, such as “what is a polar vortex”, it is ineffective in the subjective space, such as “what is the best treatment for my form of breast cancer”, because that answer is subject to the various competing points of view of the researchers in the evolving field of breast cancer.

For this reason, Facebook is now the main solution people use to discover more personalized content. It works because a person's friends and associates are more likely to share share their interests, so they can all pool their efforts in mining the Web for content they find more personally appealing. However, a person's social connections are only loosely related to one's personal interests. Thus, a Facebook users' network feed tends to be noisy and dominated by content that is trending within their social circles. Further, a social network is ineffective when one's interest is to exploring the views of alternative and competing thought leaders in a particular space.

### SUMMARY

One aspect of this inventions is taking advantage of the prevalence of curated links to documents of interest on the internet to network people around the content and to allow these people to explore subject areas from the points of view of various and competing thought leaders. The method is independent of document content, so it applies to all media types. Further, the method does not depend on any sort of metadata to define a curated area of interest, such as tags or keywords. Curated areas of interest are simply defined by the links contained within them. Given that even the cited articles within a document identify a curation around the subject matter of the document, any hyperlinked database of documents can seed the discovery network. Thus. the method provides a general technique that can network individuals around even the most niche areas of interest, over the entire range of content types available on the internet, whether that content is embodied in a linked document or a media type without links (audio, images, video), making the method potentially more widely applicable than PageRank.

In contrast to social networks like Facebook, the method gives networked users direct control over the type of content that flows to them and automatically connects them with individual around the world that share their interests or the points of view that the user wishes to explore. This is again in contrast to social networks, that require users to connect with people they know.

### BRIEF DESCRIPTION OF DRAWINGS

FIG. 1 is a flowchart of one embodiment, describing how the discovery network is constructed

### DETAILED DESCRIPTION

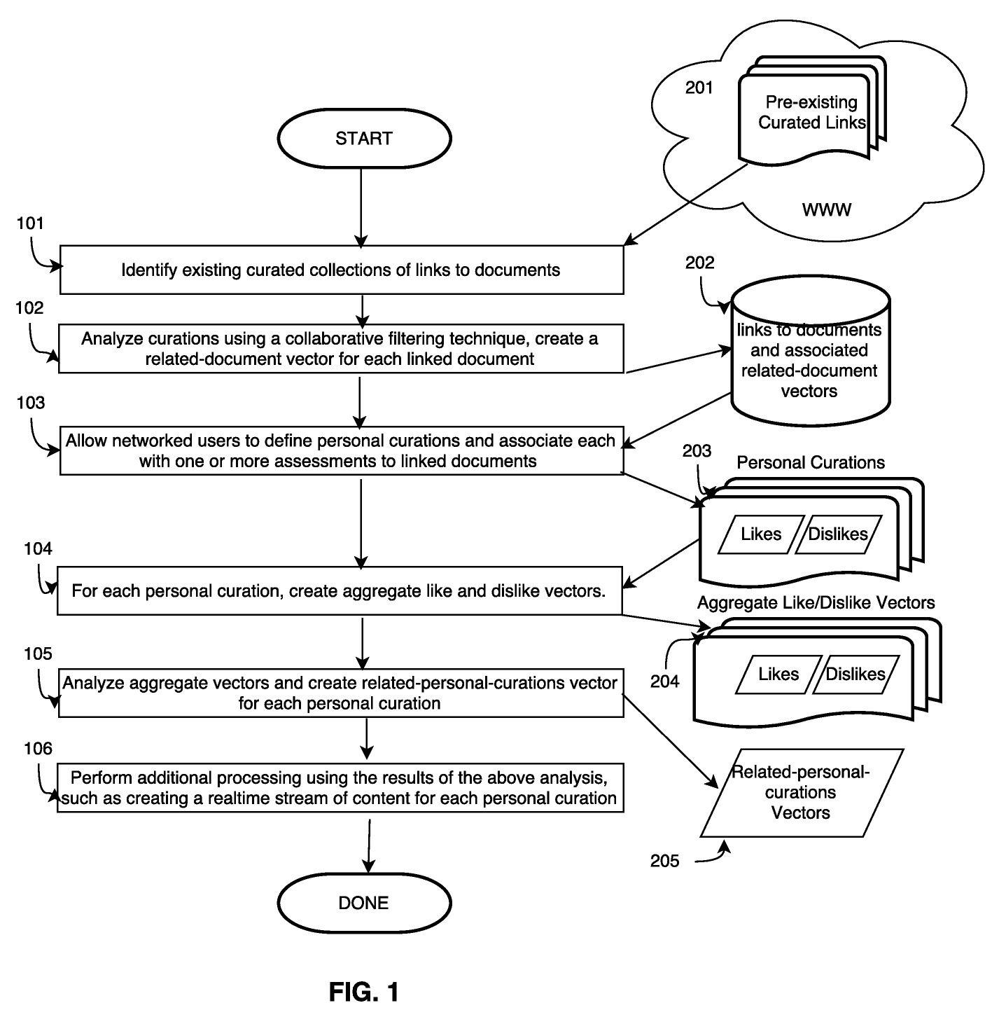

FIG. 1 shows the overall flow of how the Discovery Network is constructed.

At step 101 pre-existing curated links to documents are identified. These may be the favorite videos of individuals on Youtube or articles cited within the articles of medical journals, as this collection of cited articles is considered a curation around the subject matter of the document citing the articles.

At step 102 each of these curations is analyzed using a collaborative filtering method. Each document is associated with a related-document vector. An example primitive collaborative filtering method would be:

related-document-vector(src_id, related_id)=log ᵢᵢ(totalLikes(related_id))*(common_likes(src_id, related_id)/totalLikes(related_id))

Where:
related-document-vector(src_id, related_id) contains the strength of the relationship between source document: src_id and related document: related_id
common_likes(src_id, related_id) are the number likes in common between source document: src_id and a related document: related_id
totalLikes(related_id) are the total likes against the related document: related_id
log₁₁ of the total likes against the related document attenuates the effect of documents with a very large number of likes, while giving less weight to documents without a statistically significant number of likes

At Step 103 the networked users of the system define one or more personal curations. These are used by the user to create topical areas of interests, or competing view points they wish to explore. They then associated one or more of the preprocessed linked documents identified in steps 101 and 102, with each of their personal curations. Further, as users “drop” these documents into a personal curation they also identify if they “like” or “dislike” the document.

At Step 104 aggregate “like” and “dislike” vectors are created for each personal curation, by combining the individual “like” and “dislike” related-document vectors, respectively. This needs to be done is such a way that normalizes the effect of popular linked documents relative to less-popular linked documents. For example, when aggregating all the “liked” documents for curation j, then one could interleave the individual “like” related-document-vectors:
for each related-document-vector: src_id, liked into curation: cur_id:
   starting from position: 0, iterate through position: maxlnterleaves:

related_id=related-document-vector-at-position(src_id, position)

score=related-document-vector(src_id, related_id)*pow(E, maxInterleaves−position)

aggregate_like(related_id)=aggregate_like(related_id)+score

WHERE:
related-document-vector-at-position: provides the related_id at the specified position. Items in the vector are always order by strongest relationship first.
maxlnterleaves: is the maximum depth into any related-document-vector to be considered.
aggregate_like: is the aggregate like vector created for the personal curation
pow(E, maxInterleaves−position): normalizes the influence of popular and less popular linked documents.

At Step 105, the related-personal-curations vectors are created for each personal curation. Curations that are more closely related to one another will have a higher relationship score. This analysis is performed as follows:
1. Using the aggregate_like vector, identify the related-personal-curations vectors most closely related to the likes within the target personal curation. The strength of the relationship being proportional to the sum of the relationship strengths of the documents within the personal curation, that also exist in the aggregate_like vector
2. Using the aggregate_dislikes vector, identify the related-personal-curations vectors most closely related to the dislikes within the target personal curation. The strength of the relationship being proportional to the sum of the relationship strengths of the documents within the pre-existing curation, that also exist in the aggregate_dislike vector.
3. The strength of the relationship to the personal curation is the value obtained from step 1 minus the value obtained in step 2 above.

Once the related-personal-curations vectors are computed, various aspects of this invention may be presented to users. This is encapsulated in step 106.

At Step 106, one embodiment would be to present a realtime stream of content based on the “likes” being dropped by other users into the so identified related curations identified in step 105. This parallels the behavior of prior-art social networks. To obtain a realtime stream, this step ranks activity occurring in time ranges that doubles in length at every quantum. For example, all activity within:
0 to 1 minute
1 to 2 minutes
2 to 4 minutes
4 to 8 minutes
8 to 16 minutes
16 to 32 minutes
etc

Because exponentially more assessments are used to rank the content as one moves down the stream, the streams quality improves with age. That is, the most relevant documents percolate up as time progresses, naturally preserving the most valuable information over time.

1) A discovery network consisting of networking people around a plurality of assessed documents, comprising:
Identify a plurality of pre-existing curated collections of links to documents that exist in other sites on the web
Processing these curated collections using a collaborative filtering technique to relate the documents to one another and creating a related-document vector for each document
Where each vector is comprised of a list of similarity scores between a subject document and the set of related documents, whereas a higher similarity score indicates a closer relationship
Allowing users within the discovery network to create one or more personal curations, representing categories of interest.
Allowing these users to then associate one or more of the previously processed related documents into one or more of their personal curations and assign an assessment indicating whether they like or dislike the so identified document
For each personal curation, creating an aggregate “like” vector by combining the related-document vectors for each document given a “like” assessment and creating an aggregate “dislike” vector for the documents given a “dislike” assessment.
Whereas the similarity score of a document within the aggregate vector is derived by accumulating the similarity scores in each of the individual related-document vectors within the collection
Using these aggregate vectors to create related-personal-curations vectors, each comprised of a list of similarity scores between a target personal curation and the set of related personal curations, where:
The similarity score between two personal curations only strengthens if the similarity between their aggregate “like” vectors strengthens, where similarity is defined as the same document existing in both vectors and is proportional to the strength of the similarity scores in each of these vectors
The similarity between target personal curation and the related personal curation only decreases if the similarity between the target's aggregate “dislike” vector and the related aggregate “like” vector increases, where similarity is defined as the same document existing in both vectors and is proportional to the strength of the similarity scores in each of these vectors
Performing additional processing using the results of the above analysis and the activity associated with each personal curation
